(19) United States
(12) Patent Application Publication
(10) Pub. No.: US 2014/0220814 A1
(43) Pub. Date: Aug. 7, 2014

(54) Connector

(71) Applicant: Yazaki Corporation, Tokyo (JP)

(72) Inventors: Keishi Jinno, Makinohara-shi (JP); Kouichi Ohyama, Makinohara-shi (JP); Kazunori Miura, Makinohara-shi (JP)

(73) Assignee: Yazaki Corporation, Tokyo (JP)

(21) Appl. No.: 14/249,641

(22) Filed: Apr. 10, 2014

Related U.S. Application Data
(63) Continuation of application No. PCT/JP2012/076868, filed on Oct. 11, 2012.

(30) Foreign Application Priority Data
Oct. 11, 2011 (JP) 2011-223911

(51) Int. Cl. H01R 13/46

(52) U.S. Cl. CPC H01R 13/46
USPC 439/499

(57) ABSTRACT

A connector includes a flat shaped flexible wiring and a slider having a terminal insert part and an attaching face. A terminal formed in the flat shaped flexible wiring is connected to a mating terminal of a mating connector at the terminal insert part. The terminal insert part includes a stepped part and a plurality of protruding parts which are respectively extended rearward from the stepped part so that face positions of upper faces of the protruding part are flush with a face position of the lower face of the front end part of the terminal insert part. The end part of the flat shaped flexible wiring is arranged in a surrounding part surrounded by the attaching face, the upper faces and the stepped part.

### CROSS REFERENCE TO RELATED APPLICATIONS

This application is a continuation of PCT application No. PCT/JP2012/076868, which was filed on Oct. 11, 2012 based on Japanese Patent Application (No. 2011-223911) filed on Oct. 11, 2011, the contents of which are incorporated herein by reference.

### BACKGROUND OF THE INVENTION

1. Field of the Invention

The present disclosure relates to a connector with a flat shaped flexible wiring.

2. Description of the Related Art

Usually, for connecting together various kinds of electric devices, in order to improve a flexibility of a wiring path, a flat shaped flexible wiring connector having a flat shaped flexible wiring such as a flexible flat cable or a flexible printed circuit is used. For instance, JP-A-2006-85989 proposes a connector including a flat shaped flexible wiring and a slider having a terminal insert part. In the terminal insert part, under a state that the flat shaped flexible wiring is attached to an attaching face, the flat shaped flexible wiring is inserted into a mating connector so that a terminal formed in an end part of the flat shaped flexible wiring is connected to a mating terminal in the mating connector.

In the flat shaped flexible wiring connectors 210 and 220 disclosed in JP-A-2006-85989, as shown in FIGS. 15A and 15B, sliders 211 and 221 have protecting parts 211a and 221a protruding on attaching faces 211b and 221b so as to cover an end part 300a of a flexible flat cable 300. Otherwise, as shown in FIG. 15C, a slider 231 has a recessed part 231a formed on an attaching face 231b so that the end part 300a of the flexible flat cable 300 is bent and inserted into the recessed part. Accordingly, the end part 300a of the flexible flat cable 300 is protected by the protecting parts 211a, 221a or the recessed part 231a.

### SUMMARY OF THE INVENTION

However, in the case of structures having the protecting parts 211a and 221a as in the flat shaped flexible wiring connectors 210 and 220 disclosed in JP-A-2006-85989, since mating terminals not shown in the drawing are respectively set so as to be elastically deformed with an addition of amounts H of displacement when the mating terminals respectively get over the protecting parts 211a and 221a, an urging force by the mating terminals respectively applied to the flexible flat cable 300 become large. Thus, a contact resistance of a terminal of the flexible flat cable 300 and the mating terminals is respectively large. Accordingly, there is a fear that the terminal of the flexible flat cable 300 may be possibly broken. As a result, there is a fear that reliability in connection may be possibly deteriorated.

Further, in the case of a structure having the recessed part 231a as in the flat shaped flexible wiring connector 230, since the end part 300a of the flexible flat cable 300 needs to be bent, a problem arises that an attaching operation is complicated.

It is therefore an object of the present disclosure to provide a connector with a flat shaped flexible wiring which can be easily attached to a mating connector and can prevent reliability in connection from being deteriorated.

In order to achieve the above object, according to the present disclosure, there is provided a connector comprising:

a flat shaped flexible wiring; and

a slider having a terminal insert part and an attaching face,

wherein a terminal formed at an end part of the flat shaped flexible wiring is connected to a mating terminal of a mating connector at the terminal insert part by inserting the terminal insert part into the mating connector in a state that the flat shaped flexible wiring is attached to the attaching face;

wherein the terminal insert part includes:
a stepped part having a step between a lower face of a front end part of the terminal insert part and the attaching face, and a distance of the step being substantially equal to a thickness of the flat shaped flexible wiring; and
a plurality of protruding parts which are respectively extended rearward from the stepped part so that face positions of upper faces of the protruding parts are flush with a face position of the lower face of the front end part of the terminal insert part, and are arranged along a direction of width of the flat shaped flexible wiring so that the protruding parts are not overlapped on the terminal of the flat shaped flexible wiring in view from side of the attaching face; and

wherein the end part of the flat shaped flexible wiring is arranged in surrounding parts surrounded by the attaching face, the upper faces of the protruding parts and the stepped part.

For example, a plurality of terminals including the terminal are formed in the flat shaped flexible wiring, and the plurality of protruding parts are arranged between the adjacent terminals in view from the side of the attaching face.

For example, the plurality of protruding parts are respectively arranged between all of the adjacent terminals.

For example, the protruding parts have inclined faces inclined so that the thickness of the protruding parts in a direction of height thereof is reduced toward front ends thereof.

In the connector according to the above configurations, since the end part is arranged in the surrounding part surrounded by the attaching face, the upper faces and the stepped part, under a state that the end part is mounted on the attaching face, the end part can be easily inserted into the surrounding parts. Further, the mating terminal do not need to get over the protruding parts and the mating terminal is connected to the terminal. Thus, an urging force applied to the terminal from the mating terminal can be suppressed to a low level. Accordingly, the flat shaped flexible wiring connector can be easily attached to the mating connector and reliability in connection can be prevented from being deteriorated.

Further, in the connector according to the above configuration, since the plurality of terminals are formed in the flat shaped flexible wiring and the plurality of protruding parts are respectively arranged between the adjacent terminals in view from the side of the attaching face, even when the plurality of terminals are formed, the protruding parts can be arranged so that the protruding parts are not overlapped on the terminals.

Further, in the connector according to the above configuration, since the plurality of protruding parts are respectively arranged between all the adjacent terminals, when the terminals are arranged along the direction of width of the end part, the protruding parts can be arranged along the direction of width. As a result, an effect of preventing the generation of bending of the end part of the flat shaped flexible wiring can be improved.

Further, in the connector according to the above configuration, the protruding parts have the inclined faces inclined so that the thickness of the protruding parts in the direction of height is reduced toward the front ends. Thus, the protruding parts hardly come into contact with the mating connector. As a result, the terminal insert part is easily inserted into the mating connector.

### BRIEF DESCRIPTION OF THE DRAWINGS

FIG. 1 is a perspective view showing a connector with a flat shaped flexible wiring according to an exemplary embodiment of the present disclosure and a mating connector connected to the connector.

FIG. 2 is an enlarged perspective view of a periphery of a mating terminal of the mating connector shown in FIG. 1.

FIG. 3 is an exploded perspective view of the connector shown in FIG. 1 which is seen from an obliquely lower part.

FIG. 4 is a top view of an FPC shown in FIG. 1.

FIG. 5 is a side view of the FPC shown in FIG. 4.

FIG. 6 is a perspective view of the connector shown in FIG. 1 which is seen from an obliquely lower part.

FIG. 7 is an enlarged view of the periphery of protruding parts shown in FIG. 6.

FIG. 8 is a sectional view taken along a line A-A of the connector shown in FIG. 7.

FIG. 9 is a perspective view of the connector shown in FIG. 1 which is seen from an obliquely lower part.

FIG. 10 is an enlarged view of the periphery of protruding parts shown in FIG. 9.

FIGS. 11A to 11C are diagrams showing an attaching procedure of the connector.

FIGS. 12A to 12C are diagrams showing a flow from a process that a terminal insert part begins to be inserted into the mating connector to a process that the connector and the mating connector are fixed to each other.

FIG. 13 is a perspective view of a connector of a modified example of the exemplary embodiment according to the present disclosure which is seen from an obliquely lower part.

FIG. 14 is an enlarged view of the periphery of protruding parts shown in FIG. 13.

FIGS. 15A to 15C are diagrams for explaining a related art.

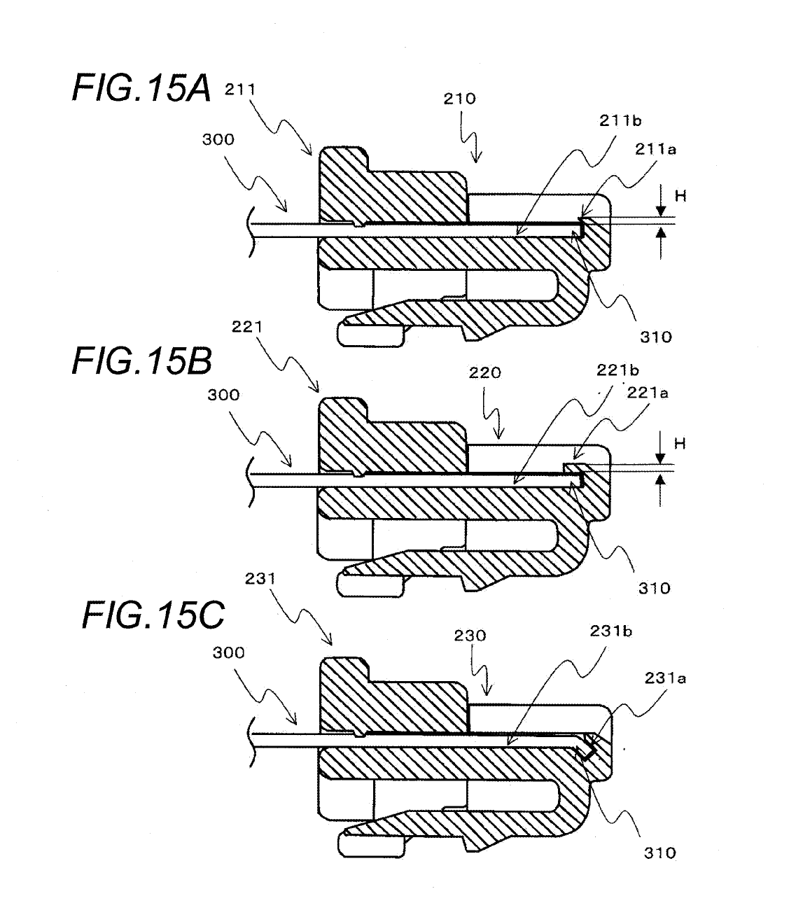

### DETAILED DESCRIPTION OF THE EXEMPLARY EMBODIMENTS

Now, referring to the drawings, a preferred exemplary embodiment of a flat shaped flexible wiring connector according to the present disclosure will be described below in detail.

### Exemplary Embodiment

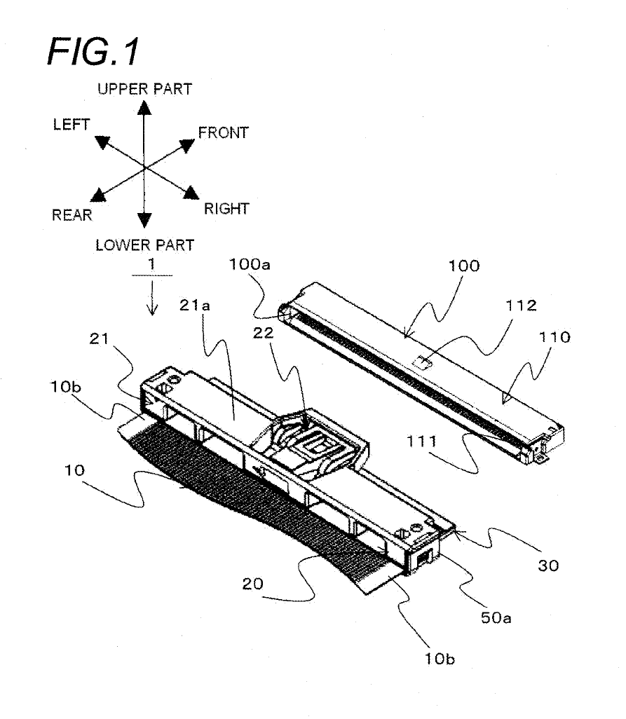

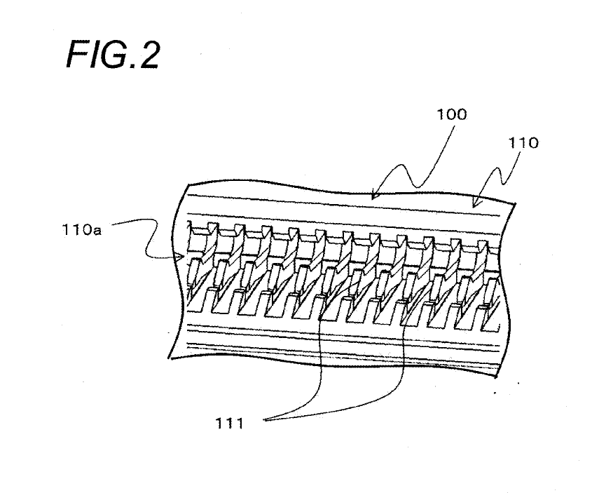

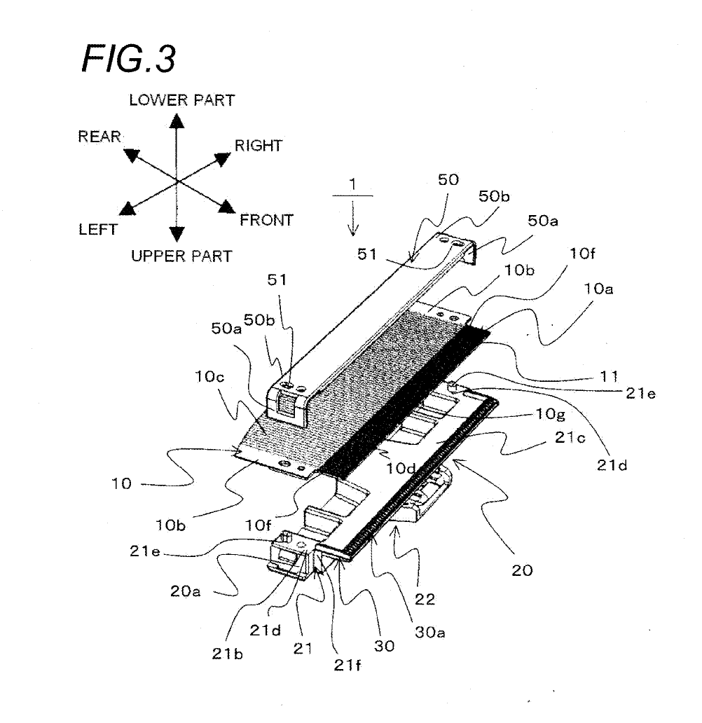

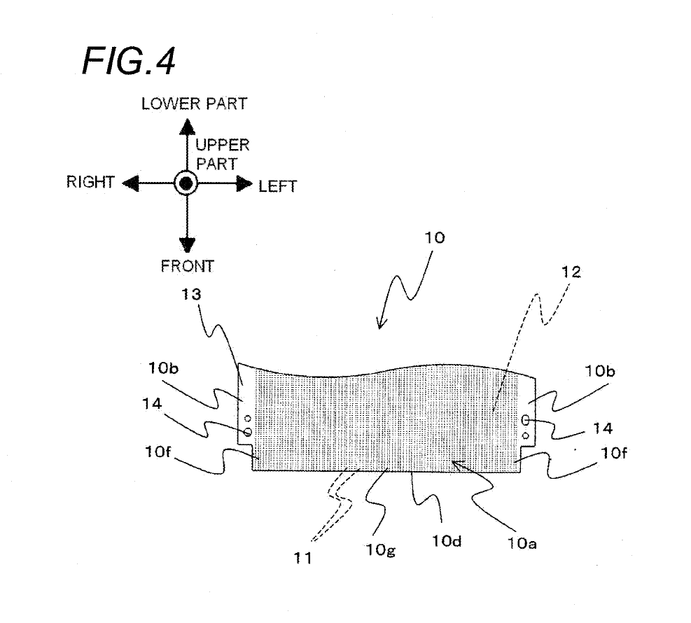

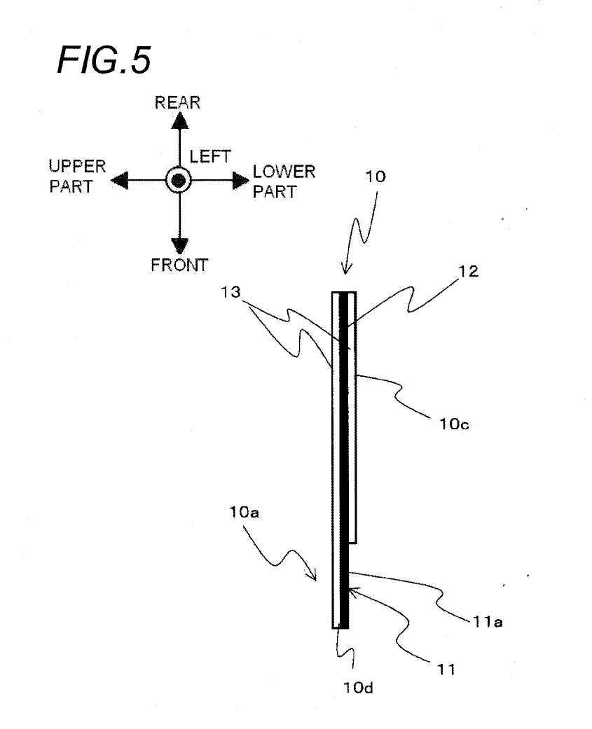

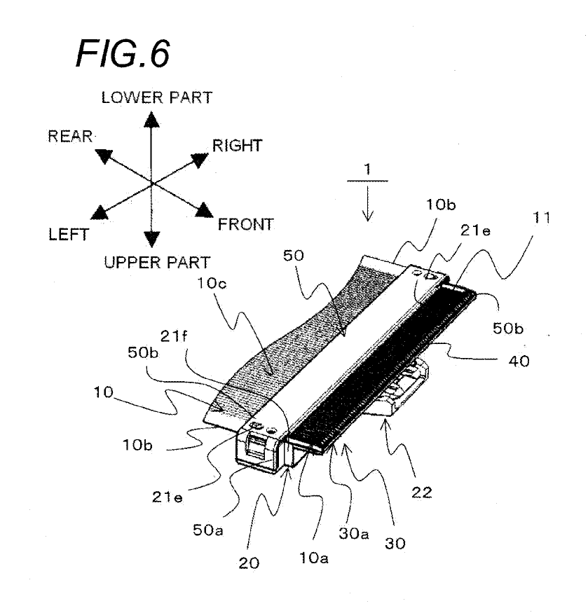

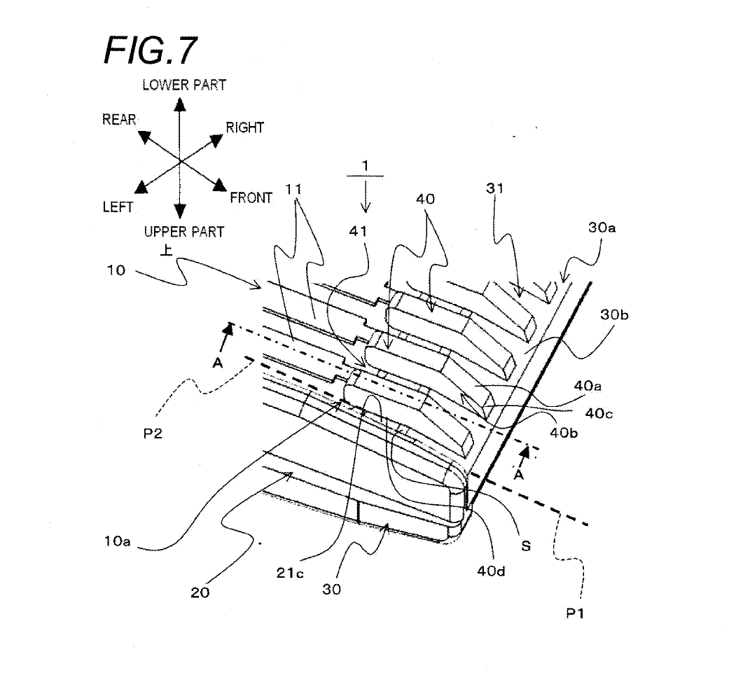

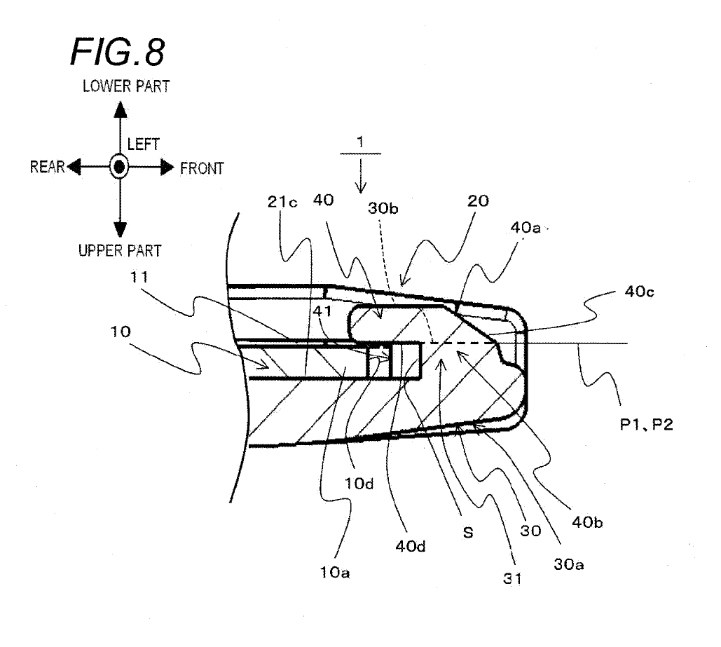

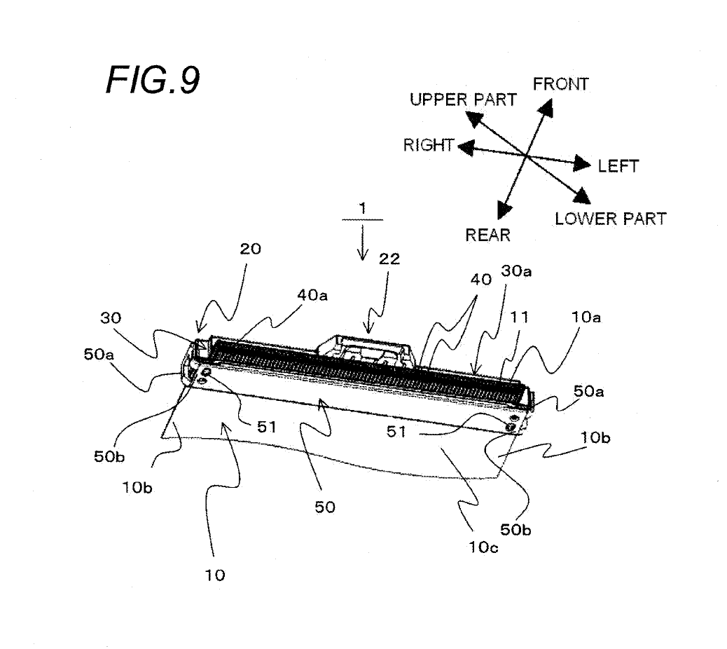

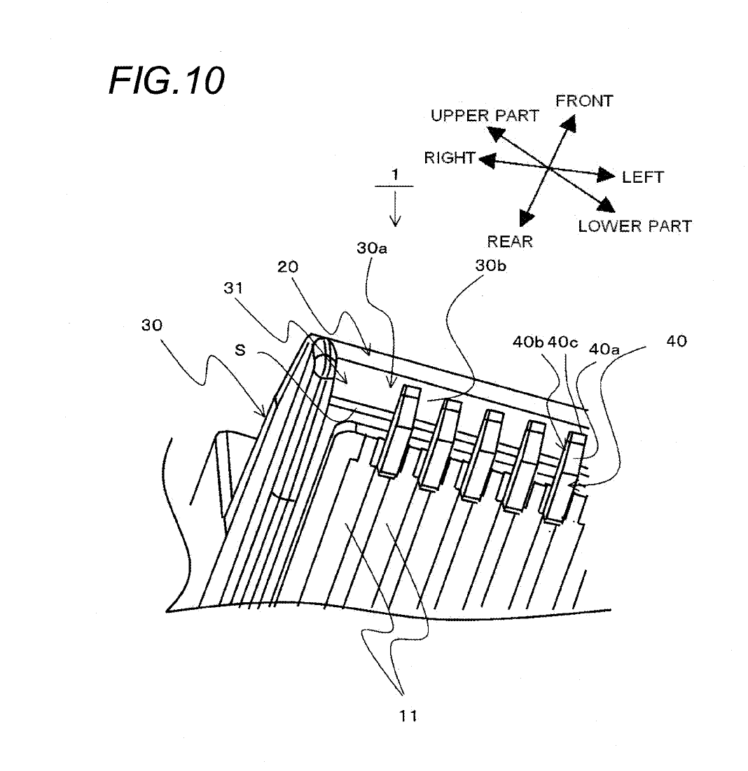

FIG. 1 is a perspective view showing a connector with a flat shaped flexible wiring 1 according to an exemplary embodiment of the present disclosure and a mating connector 100 connected to the connector 1. FIG. 2 is an enlarged perspective view of a periphery of a mating terminal 111 of the mating connector 100 shown in FIG. 1. FIG. 3 is an exploded perspective view of the connector 1 shown in FIG. 1 which is seen from an obliquely lower part. FIG. 4 is a top view of an FPC 10 shown in FIG. 1. FIG. 5 is a side view of the FPC 10 shown in FIG. 4. FIG. 6 is a perspective view of the connector 1 shown in FIG. 1 which is seen from an obliquely lower part. FIG. 7 is an enlarged view of the periphery of protruding parts 40 shown in FIG. 6. FIG. 8 is a sectional view taken along a line A-A of the connector 1 shown in FIG. 7. FIG. 9 is a perspective view of the connector 1 shown in FIG. 1 which is seen from an obliquely lower part. FIG. 10 is an enlarged view of the periphery of protruding parts 40 shown in FIG. 9.

For convenience sake, directions shown by mutually orthogonal arrow marks in the drawings are set as forward, rearward, rightward, leftward and upward and downward directions.

The connector 1 according to the exemplary embodiment of the present disclosure includes a flexible printed circuit 10 (refer it to as an FPC, hereinafter) as a flat shaped flexible wiring, a slider 20 to which the FPC 10 is attached and which has a terminal insert part 30, and a slider cover 50 attached to the slider 20 so as to sandwich the FPC 10 between the slider 20 and the slider cover 50. At the terminal insert part 30, terminals 11 formed in an end part 10a of the FPC 10 are connected to mating terminals 111 in the mating connector 100 when the slider 20 is inserted into the mating connector 100.

Initially, the mating connector 100 will be described below.

As shown in FIG. 1 and FIG. 2, the mating connector 100 includes a box shaped housing part 110 having an opening part 110a formed in a rear end part into which the terminal insert part 30 of the slider 20 is inserted and a plurality of mating terminals 111 provided in an accommodating space in the housing part 110 and respectively connected to the terminals 11 of the FPC 10. The mating terminals 111 are respectively electrically connected to, for instance a circuit board not shown in the drawing in a lower part of the housing part 110.

On an upper face of the housing part 110, an engaging protrusion 112 is provided with which a below-described connector engaging part 22 of the slider 20 is engaged. When the engaging protrusion 112 is engaged with the connector engaging part 22, the connector 1 is fixed to the mating connector 100.

Now, the FPC 10 will be described blow.

As shown in FIG. 4 and FIG. 5, the FPC 10 has a circuit wiring 12 having an electrically conductive metal film patterned and formed. Both faces of the circuit wiring 12 are flat plate shaped flexible circuit boards covered with insulating thin films 13.

In the end part 10a of the FPC 10, a plurality of terminals 11 are arranged and formed. A part of the insulating thin film 13 is removed to expose respectively connecting faces 11a of the terminals 11 in a connecting side so that the terminals 11 may be respectively connected to the mating terminals 111.

Further, in both side end parts 10b in a longitudinal direction of the FPC 10, circular positioning holes 14 are formed. When the FPC 10 is attached to the slider 20, below-described positioning protrusions 21e protruding from a below-described attaching face 21c of the slider 20 are respectively inserted into the positioning holes 14. Thus, an attaching position of the FPC 10 is positioned to the slider 20.

Now, the slider 20 will be described below.

The slider 20 is made of an insulating material. As shown in FIG. 1 and FIG. 3, the slider 20 includes a slider base part 21, the connector engaging part 22 provided in an upper part 21a of the slider base part 21 and the terminal insert part 30.

The slider base part 21 is a base part formed substantially in the shape of a rectangular parallelepiped. The slider base part 21 has the attaching face 21c to which the FPC 10 is attached in a lower face 21b. As shown in FIG. 3, in both end pars 21d in the longitudinal direction of the attaching face 21c, the positioning protrusions 21e are formed which protrude downward from the attaching face 21c. When the FPC 10 is attached to the slider 20, the positioning protrusions 21e are respectively inserted into the positioning holes 14 of the FPC 10, so that the attaching position of the FPC 10 is positioned to the slider 20.

The connector engaging part 22 is engaged with the engaging protrusion 112 provided in the mating connector 100, so that the connector 1 is fixed to the mating connector 100.

The terminal insert part 30 is a part to which the FPC 10 is attached and which is inserted into the mating connector 100 to connect the terminals 11 to the mating terminals 111 in the mating connector 100. As shown in FIG. 6 to FIG. 10, the terminal insert part 30 is provided to protrude from a front end 21f of a lower part of the slider base part 21 so as to extend the attaching face 21c forward. As shown in FIG. 8, stepped parts 31 are formed in a front end part 30a.

The stepped parts 31 form a lower face 30b of the front end part of the terminal insert part 30. A step (difference) S between the lower face 30b of the front end part and the attaching face 21c is formed so as to be substantially equal to the thickness of the FPC 10.

When the terminal insert part 30 is inserted into the mating connector 100, the mating terminals 111 are allowed to abut on the stepped parts 31 due to the existence of the above-described stepped parts 31 and contacts of the mating terminals 111 are located at heights substantially equal to the position of a lower face 10c of the FPC 10. Accordingly, when the terminal insert part 30 is inserted into the mating connector 100, an edge 10d of the end part 10a of the FPC 10 is not allowed to abut on the mating terminals 111 respectively so as to deform the end part 10a.

Further, the terminal insert part 30 has a plurality of protruding parts 40 which hold the end part 10a of the FPC 10.

The protruding parts 40 are respectively extended rearward from the stepped parts 31 in such a way that face positions P2 of upper faces 40d of the protruding parts 40 are flush with a face position P1 of the lower face 30b of the front end part and distributed and arranged along a direction of width of the end part 10a so that the protruding pieces 40 are not overlapped on the terminals 11 when they are seen from the attaching face 21c side.

In the present exemplary embodiment, the protruding parts 40 are respectively arranged between all the adjacent terminals 11 when they are seen from the attaching face 21c side.

Further, in front end parts 40b of the protruding parts 40 respectively, inclined faces 40a are formed.

The inclined faces 40a are faces inclined so that the thickness of the protruding parts 40 in the direction of height is reduced toward front ends 40c. When the terminal insert part 30 is inserted into the mating connector 100, the inclined faces 40a function as relief parts which hardly allow the protruding parts 40 to come into contact with the mating connector 100.

In the present exemplary embodiment, the protruding parts 40 are exemplified which have the inclined faces 40a, however, the present disclosure is not limited thereto. Namely, as long as the terminal insert part 30 is inserted into the mating connector 100, for instance, corners of the front end parts 40b of the protruding parts 40 may be formed to be curved in place of the inclined faces 40a.

In such a slider 20, a surrounding part 41 is formed which is surrounded by the attaching face 21c, the upper faces 40d of the protruding parts 40 and the step S of the stepped parts 31. Since the end part 10a of the FPC10 is arranged in the surrounding part 41, the end part 10a is held and protected by the slider 20.

Further, since the protruding parts 40 are respectively arranged between all the adjacent terminals 11 when they are seen from the attaching face 21c side (lower part side in FIG. 7), the end part 10a is held which includes a part near both side end parts 10f and a part near a central part 10g in the direction of width. Accordingly, the end part 10a of the FPC 10 is prevented from being bent.

Further, when the terminal insert part 30 is inserted into the mating connector 100, the protruding parts 40 do not respectively interfere with the mating terminals 111. Accordingly, the mating terminals 111 do not need to get over the protruding parts 40. Thus, an amount of elastic deformation of the mating terminals 111 can be suppressed. Thus, an urging force applied when the mating terminals 111 are respectively connected to the terminals 11 can be suppressed to a low level.

Now, the slider cover 50 will be described below.

The slider cover 50 is a plate shaped member of a substantially rectangular form in an outer form having a longitudinal direction of the slider 20 as a longitudinal direction. As shown in FIG. 3 and FIG. 6, both edges 50a in the longitudinal direction are bent upward to abut on side parts 20a of the slider 20. On both end parts 50b of the slider cover 50 in the longitudinal direction, fixing holes 51 are formed into which the positioning protrusions 21e are inserted when the slider cover 50 is attached to the slider 20. When the positioning protrusions 21e are inserted into the fixing holes 51, the slider cover 50 is fixed to the slider 20.

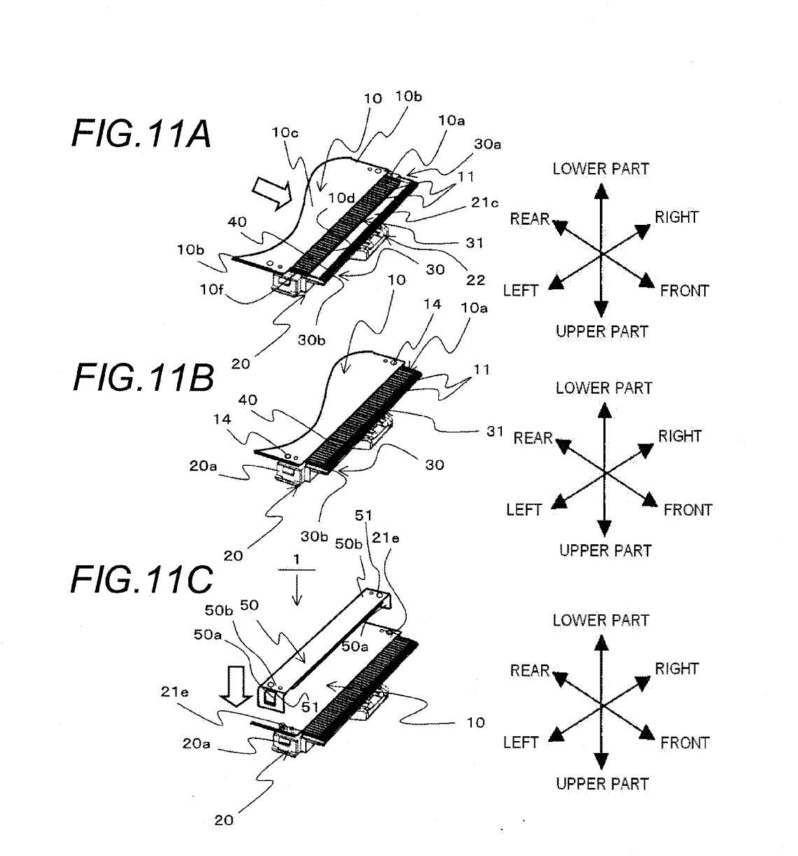

Now, referring to FIGS. 11A to 11C, an attaching procedure of the connector 1 will be described below. FIGS. 11A to 11C are diagrams showing the attaching procedure of the connector 1.

Initially, an operator inserts the end part 10a of the FPC 10 into the surrounding part 41 of each protruding part 40 (see FIG. 11A). At this time, under a state that the end part 10a of the FPC 10 is mounted on the attaching face 21c, the end part 10a can be inserted into each of the surrounding parts 41. Namely, the operator can easily insert the end part 10a into the surrounding part 41 along the attaching face 21c without bending the end part 10a.

Then, the operator attaches the FPC 10 to a prescribed position on the attaching face 21c of the slider 20 by inserting the positioning protrusions 21e into the positioning holes 14 (see FIG. 11B).

After that, the operator fixes the slider cover 50 to the slider 20 by inserting the positioning protrusions 21e into the fixing holes 51 of the slider cover 50 (see FIG. 11C). Thus, the FPC 10 is sandwiched between the slider 20 and the slider cover 50. In such a way, an attaching operation of the connector 1 is completed.

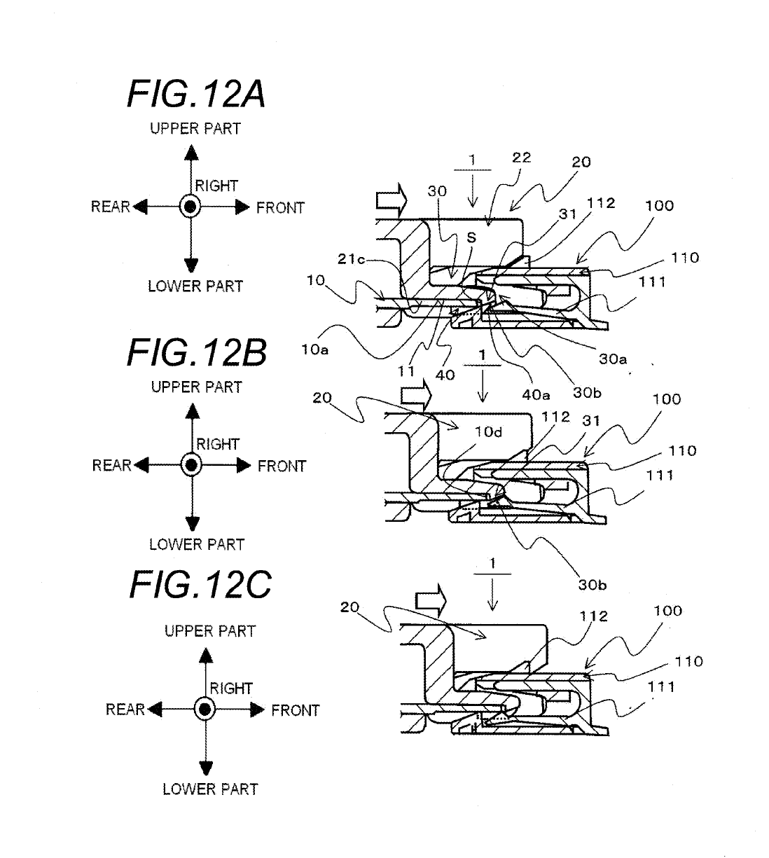

Now, by referring to FIGS. 12A to 12C, a flow from a process that the terminal insert part 30 begins to be inserted to the mating connector 100 to a process that the connector 1 and the mating connector 100 are fixed to each other.

FIGS. 12A to 12C are diagrams showing the flow from the process that the terminal insert part 30 begins to be inserted to the mating connector 100 to the process that the connector 1 and the mating connector 100 are fixed to each other.

Initially, the operator begins to insert the terminal insert part 30 to the mating connector 100 (see FIG. 12A. When the terminal insert part 30 begins to be inserted to the mating connector 100, the mating terminals 111 respectively initially abut on the stepped parts 31 and the contacts of the mating terminals 111 are respectively located at the height of the lower face 10c of the FPC 10. Accordingly, the mating terminals 111 are not respectively allowed to abut on the edge 10d of the FPC 10. Thus, the terminal insert part 30 is smoothly inserted to the mating connector 100.

Subsequently, when the terminal insert part 30 is further inserted to the mating connector 100 by the operator, the protruding parts 40 are respectively moved between the mating terminals 111 (see FIG. 12B). In such a way, since the protruding parts 40 are respectively moved between the mating terminals 111, the mating terminals 111 are not respectively allowed to abut on the protruding parts 40. Namely, the mating terminals 111 are respectively moved without getting over the protruding parts 40.

Then, when the terminal insert part 30 is inserted to an attaching position in the mating connector 100 by the operator, the engaging protrusion 112 is engaged with the connector engaging part (see FIG. 12C). Thus, the plate shaped flexible wiring connector 1 is completely connected to the mating connector 100 and the terminals 11 are respectively connected to the mating terminals 111 at prescribed positions.

In the plate shaped flexible wiring connector 1 according to the exemplary embodiment of the present disclosure, the terminal insert part 30 includes the stepped part 31 forming the lower face 30b of the front end part of the terminal insert part 30 and having the step S between the lower face 30b of the front end part and the attaching face 21c formed so as to be substantially equal to the thickness of the FPC 10 and the plurality of protruding parts 40 respectively extended rearward from the stepped parts 31 in such a way that the face positions P2 of the upper faces 40d are flush with the face position P1 of the lower face 30b of the front end part and distributed and arranged along the direction of width of the end part 10a so that the protruding parts 40 are not overlapped on the terminals 11 when they are seen from the attaching face 21c side. Since the end part 10a is arranged in the surrounding parts 41 surrounded by the attaching face 21c, the upper faces 40d and the step S, under a state that the end part 10a is mounted on the attaching face 21c, the end part 10a can be easily inserted into the surrounding parts 41. Further, the mating terminals 111 respectively do not need to get over the protruding parts 40 and the mating terminals 111 are respectively connected to the terminals 11. Thus, an urging force respectively applied to the terminals 11 from the mating terminals 111 can be suppressed to a low level. Accordingly, the terminal insert part 30 can be easily attached to the mating connector 100 and reliability in connection can be prevented from being deteriorated.

Further, in the connector 1 according to the exemplary embodiment of the present disclosure, since the plurality of terminals 11 are formed in the FPC 10 and the plurality of protruding parts 40 are respectively arranged between the adjacent terminals 11 when they are seen from the attaching face 21c side, even when the plurality of terminals 11 are formed, the protruding parts 40 can be distributed and arranged so that the protruding parts 40 are not overlapped on the terminals 11.

Further, in the connector 1 according to the exemplary embodiment of the present disclosure, since the plurality of protruding parts 40 are respectively arranged between all the adjacent terminals 11, when many terminals 11 are arranged along the direction of width of the end part 10a, many protruding parts 40 can be arranged along the direction of width. As a result, an effect of preventing the generation of bending of the end part 10a of the FPC 10 can be improved.

Further, in the connector 1 according to the exemplary embodiment of the present disclosure, the protruding parts 40 have the inclined faces 40a inclined so that the thickness of the protruding parts 40 in the direction of height is reduced toward the front ends 40c. Thus, the protruding parts 40 hardly come into contact with the mating connector 100. As a result, the terminal insert part 30 is easily inserted into the mating connector 100.

### Modified Example

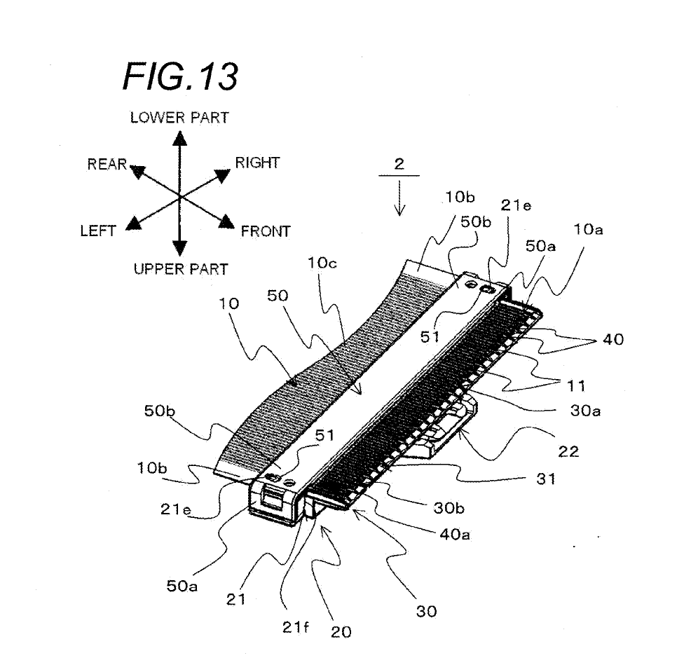

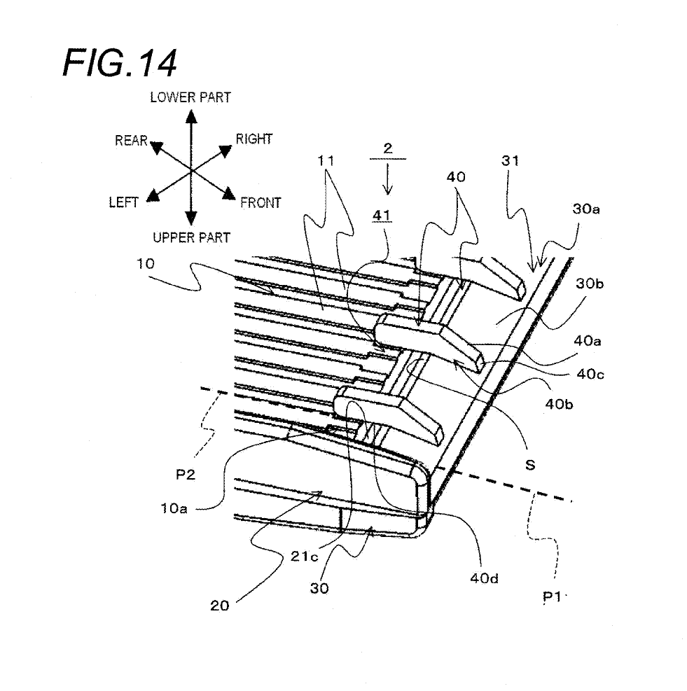

Now, a modified example of the connector 1 according to the exemplary embodiment of the present disclosure will be described below by referring to FIG. 13 and FIG. 14. FIG. 13 is a perspective view of a flat shaped flexible wiring connector 2 of a modified example of the exemplary embodiment according to the present disclosure which is seen from an obliquely lower part. FIG. 14 is an enlarged view of the periphery of protruding parts 40 shown in FIG. 13.

The flat shaped flexible wiring connector 2 of the modified example is different from the connector 1 of the exemplary embodiment in view of a point that the protruding parts 40 are respectively arranged at intervals of two terminals 11. Other structures are the same as those of the exemplary embodiment and the same component parts as those of the exemplary embodiment are designated by the same reference numerals.

In the flat shaped flexible wiring connector 2, arrangement spaces of the protruding parts 40 are respectively set to be larger than those of the connector 1 and the protruding parts 40 are respectively distributed and arranged along a direction of width of an end part 10a of an FPC 10 when they are seen from an attaching face 21c side.

Accordingly, the flat shaped flexible wiring connector 2 can be easily attached like the connector 1 and reliability in connection can be prevented from being deteriorated.

In the exemplary embodiment according to the present disclosure, as the flat shaped flexible wiring, the FPC 10 is used as an example. However, other wiring which is the flat shaped flexible wiring may be used. For instance, a flexible flat cable may be used.

In the exemplary embodiment according to the present disclosure, the FPC 10 having the plurality of terminals 10 is exemplified. However, the present disclosure is not limited thereto. Namely, an FPC having one or more terminal may be used.

As mentioned above, the invention devised by the inventor is specifically described in accordance with the above-described exemplary embodiment of the present disclosure, however, the present disclosure is not limited to the above-described exemplary embodiment of the present disclosure, and may be variously changed within a scope which does not deviate from the gist thereof.

A connector with a flat shaped flexible wiring can be easily attached to a mating connector and can prevent reliability in connection from being deteriorated.

What is claimed is:

1. A connector comprising:
a flat shaped flexible wiring; and
a slider having a terminal insert part and an attaching face,
wherein a terminal formed at an end part of the flat shaped flexible wiring is connected to a mating terminal of a mating connector at the terminal insert part by inserting the terminal insert part into the mating connector in a state that the flat shaped flexible wiring is attached to the attaching face;
wherein the terminal insert part includes:
a stepped part having a step between a lower face of a front end part of the terminal insert part and the attaching face, and a distance of the step being substantially equal to a thickness of the flat shaped flexible wiring; and
a plurality of protruding parts which are respectively extended rearward from the stepped part so that face positions of upper faces of the protruding parts are flush with a face position of the lower face of the front end part of the terminal insert part, and are arranged along a direction of width of the flat shaped flexible wiring so that the protruding parts are not overlapped on the terminal of the flat shaped flexible wiring in view from side of the attaching face; and
wherein the end part of the flat shaped flexible wiring is arranged in surrounding parts surrounded by the attaching face, the upper faces of the protruding parts and the stepped part.

2. The connector according to claim 1, wherein a plurality of terminals including the terminal are formed in the flat shaped flexible wiring; and
wherein the plurality of protruding parts are arranged between the adjacent terminals in view from the side of the attaching face.

3. The connector according to claim 2, wherein the plurality of protruding parts are respectively arranged between all of the adjacent terminals.

4. The connector according to claim 1, wherein the protruding parts have inclined faces inclined so that the thickness of the protruding parts in a direction of height thereof is reduced toward front ends thereof.

5. The wire harness according to claim 2, wherein each of the terminals has a small width part and a large width part which is larger in width extending a direction perpendicular to an extending direction of the terminal than the small width part.

6. The wire harness according to claim 5, wherein the small width part is located close to the each surrounding part rather than the large width part, and a distance between the small width part and the each surrounding part is smaller than a distance between the large width part and the each surrounding part; and
wherein the small width parts of the terminals are arranged between the adjacent protruding parts respectively.
